(19) United States
(12) Patent Application Publication
(10) Pub. No.: US 2005/0141221 A1
(43) Pub. Date: Jun. 30, 2005

(54) LED bulb with remote controller

(76) Inventor: Mu-Chin Yu, Tu Cheng City (TW)

Correspondence Address: Mu-Chin Yu, P.O. Box No. 6-57, Junghe, Taipei, 235, TW

(21) Appl. No.: 10/846,577

(22) Filed: May 17, 2004

(30) Foreign Application Priority Data
Dec. 26, 2003 (TW) 092222716

(51) Int. Cl. F21V 33/00

(52) U.S. Cl. 362/253

(57) ABSTRACT

A LED bulb with a remote controller is disclosed. The equipment includes a remote controller and a LED illuminator set, wherein the LED illuminator set comprises a base including a LED luminary, a circuitry controller, and an encoder; a globe engaged with the base; a base casing for housing the base; and a receiver disposed on the surface of the casing for receiving coded signal from the remote controller. Thereby the circuitry controller is controlled in response to the coded signal and make the LED illuminator providing a light in a demanding color.

### BACKGROUND OF THE INVENTION

(a) Field of the Invention

The present invention relates to a LED bulb, especially to a remote-controlled LED bulb.

(b) Description of the Prior Art

Compared to conventional lighting such as incandescent lamps, tungsten halogen Illuminator, fluorescence lights, the LED lighting technology has following advantages:

1. Low energy requirement: the LED light source, compared to the traditional light source with the same luminous efficiency, can save over 80% energy consumption. For example, lights on a 2000-meter-long bridge consume only 10 watt of electricity per hour so that several hundred thousands can be saved per year.

2. Reduced maintenance cost: LEDs do not require any special equipment or drivers, to deal with various environments. And there is no need to replace the light source frequently, the maintenance costs and replacement expenses are reduced dramatically.

3. Longer lifetime: the LED made of semiconductor can convert electric power into light energy. Sealed by epoxy, it can stand high shock and vibration. The LED illuminator normally works for at least twenty thousand hours, even lasts up to hundred thousand hours. Calculation based on 12 hours per day, the light source would be used over 5 years.

4. Higher energy efficiency: the luminous efficiency of the incandescent or halogen sources is 12-24 Im/W and that of the fluorescence lights is 50-120 Im/W. Incandescent or halogen sources, generates most of their light as heat and only produce 10% useful visible light. In order to have a single color, it is necessary to use a color filter to eliminate other colors thus causes the waste of energy. The luminous efficiency of the LED light is 50-200 Im/W with narrow spectrum and single color, no need to user a color filter. The useful visible light only consume 10% energy emitted from the light source.

5. Easy assembling with stableness: even with the temperature extremes, high shock and vibration environment, the LEDs driven by direct current still works stably.

6. Higher safety: the light strength of LED light is adjustable and stable, with lower glare, heat generation, and less ultraviolet light. As a cold light source, users can touch the lamp. No mercury content thus has no harm.

The LED illuminator based on new LED technology with features in low power waste, long life span, shock resistance, easiness of control.

Without the pollution of mercury or other gas emitted, it's environmental friendly.

The LED light source not only provide illumination but also provide better choice for landscaping design of cities. However, the LED illuminators available on the market all need complicated control flow and provide flat illumination. For aesthetic reason, the LED illuminator should have multiple colors.

The traditional way is to use a set or several set of LED lights controlled by control circuitry. Only the intensity scale capability can be used to produce different colors and the result is monotonous.

Therefore, there is a need to provide a LED bulb that can be controlled in an easy way and provides various combinations of different color lights.

### SUMMARY OF THE INVENTION

It is a primary object of the present invention is to provide a remote-controlled colorful LED bulb made of a plurality of LED illuminators. Through a remote controller, various combinations of different color lights emitted from LED illuminators can be achieved.

A further object of the present invention is to provide a colorful LED bulb controlled by a simple control device and providing color lights.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1(a)-1(c) is a perspective view of a LED illuminator in accordance with a preferred embodiment of the present invention.

FIG. 2 is a schematic drawing of remote circuitry of the present invention.

FIG. 3 shows the circuitry of the remote controller of the present invention.

FIG. 4 shows the circuitry of a light bulb in accordance with the present invention.

### DETAILED DESCRIPTION OF THE PREFERRED EMBODIMENT

The present invention relates to a LED luminary with a remote controller with simple structure, easy for assembling, and having various control modes.

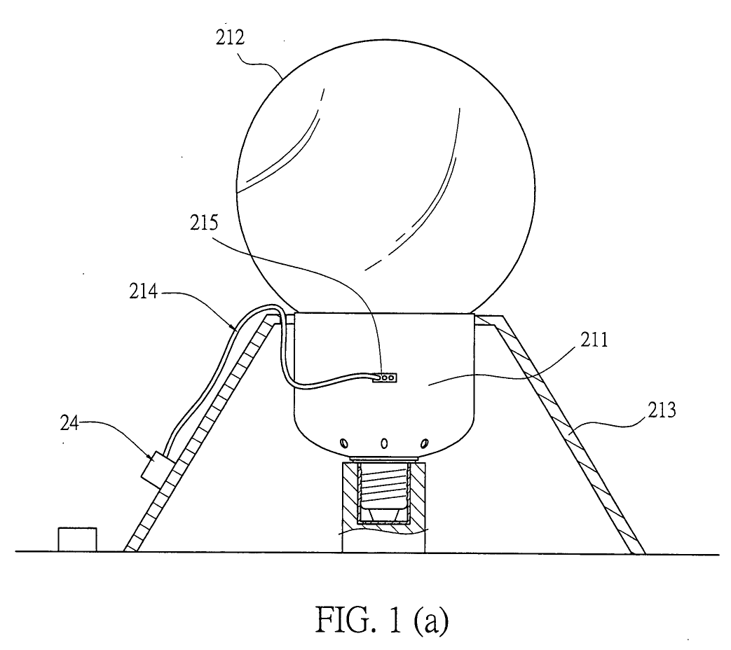

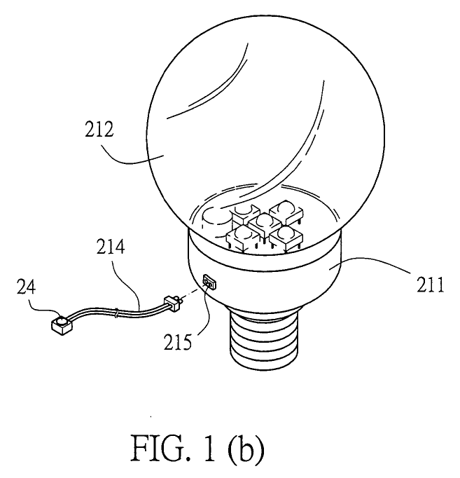

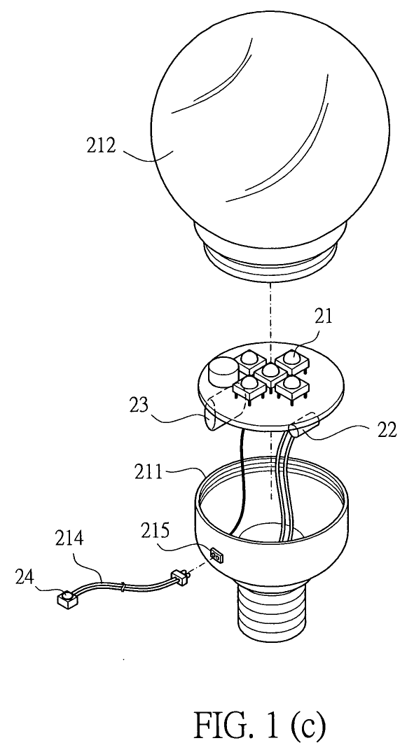

Refer FIG. 1(a)-1(c), an LED bulb of the present invention is composed of a base 211 having a LED illuminator set 21, a circuitry controller 22 and a decoder 23, a globe 212 assembling with the base 211 to form a bulb for mixing the light emitted from the LED illuminator set 21, a base casing 213 for housing the base 211, a receiver 24 disposed on the surface of the base casing 213 for receiving signals from a remote controller 1. The receiver 24 is connected to a plug 215 inserted in the base 211 by a wire 214 for receiving the coded signal sending from the remote controller 1.

In actual applications, the LED illuminator set 21 includes at least one red, one blue, one green, one yellow LED or different combinations. The receiver 24 is an infra-red receiver. The light bulb 2 further includes a power supply as a power source for the LED illuminator set 21, wherein the power supply further having a circuitry for AC to DC converter and power supply 25. The circuitry controller 22 is a switching function circuitry 221 and further having an amplifier 222 for increasing the control signals.

Another embodiment of the present invention includes a remote controller 1 for generating signals in code, a base 211 having a LED illuminator set 21, a circuitry controller 22 and a decoder 23, a globe 212 combined with the base 211 to form a light bulb in which the light emitted from the LED illuminator set 21 is mixed, a base casing 213 for housing the base 211, and a receiver 24 arranged on the base casing 213 for receiving the coded signal generated from the remote controller 1.

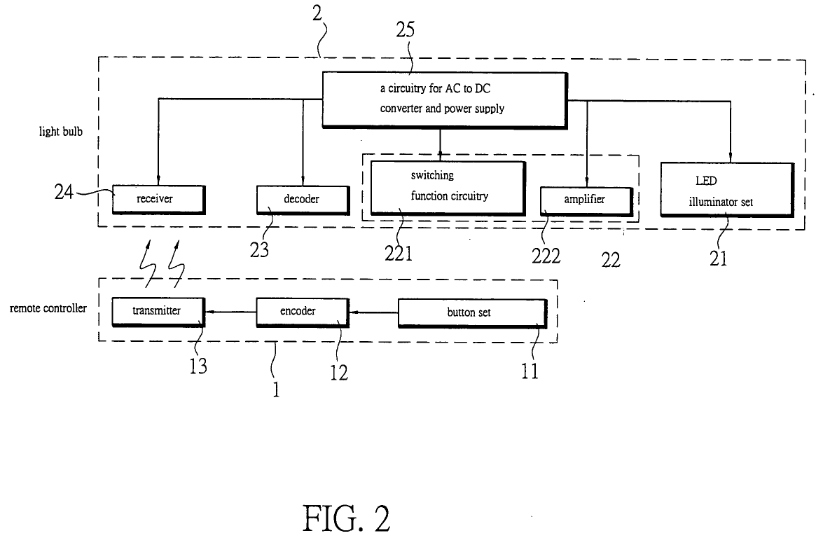

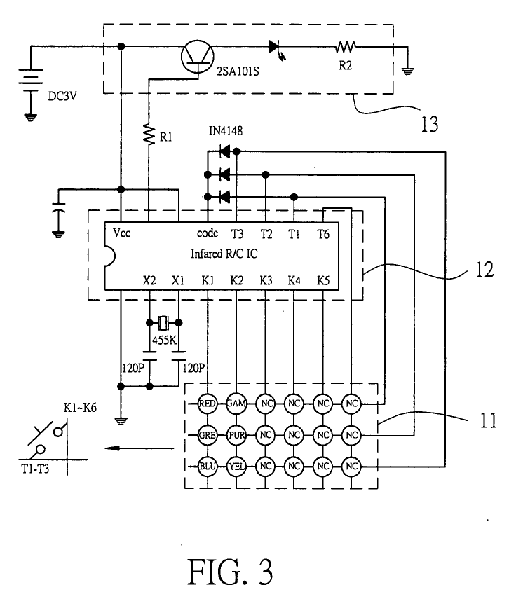

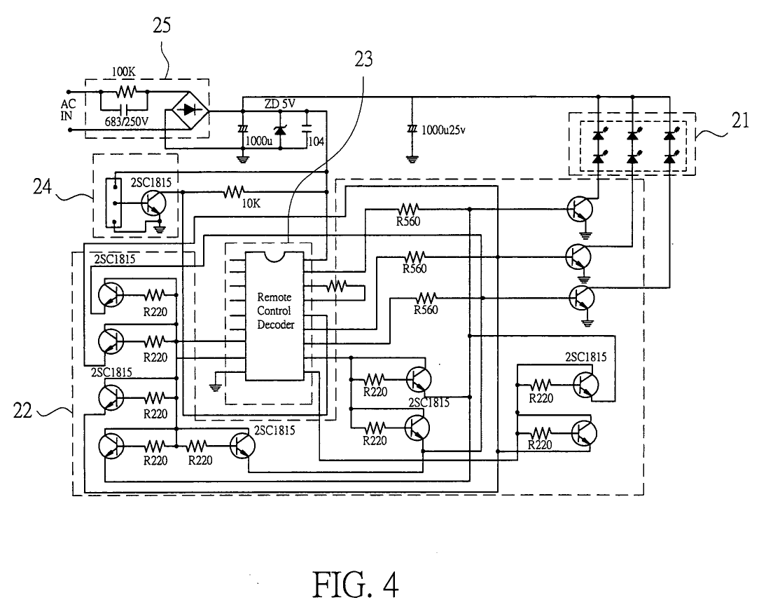

Refer to FIG. 2, this figure discloses the schematic drawing of the remote circuitry. The LED luminary includes a remote controller 1 and a light bulb 2. The remote controller 1 has at least one button set 11 with a plurality of buttons for inputting operation signals, an encoder 12 connected to the buttons for making the operation signals produced by the button set 11 in code. While the light bulb 2 includes at least a LED illuminator set 21 that is composed by a plurality of LED illuminator emitting various kind of colors respectively; a circuitry controller 22 is connected to the LED illuminator set 21 for making each of the LED illuminators emitting their light of color; a receiver 24 for receiving the signals in code transmitted from the remote controller 1; and a decoder 23 arranged between the circuitry controller 22 and the receiver 24 for receiving the signals in code and decoding for producing control signals so as to control the circuitry controller 22. Each of the LED illuminator set 21 is controlled by the corresponding buttons of the remote controller 1 so as to emit light with necessary colors. The FIG. 3 & FIG. 4 show the circuitry of the remote controller 1 and the light bulb 2 respectively.

Therefore, users' can choose the color of the LED illuminator from remote end.

It should be noted that the above description and accompanying drawings are only used to illustrated some embodiments of the present invention, not intended to limit the scope thereof. Any modification of the embodiments should fall within the scope of the present invention.

1. A LED bulb comprising:
a base having a LED illuminator set, a circuitry controller and a decoder,
a globe that is matched with the base to form a light bulb in which the light emitted from the LED illuminator set is mixed,
a base casing for housing the base, and
a receiver arranged on the base casing for receiving signals in code sending from a remote controller.

2. The LED bulb as claimed in claim 1, wherein the remote controller further having a button set that is composed by a plurality of buttons for generating operation signals,
an encoder connected with said buttons for coding the operation signals into the coded signals, and
a transmitter connected to the encoder for sending the coded signals to the receiver.

3. The LED bulb as claimed in claim 1, wherein the LED illuminator set having a plurality of LED illuminator, each of which generates a kind of color light.

4. The LED bulb as claimed in claim 3, wherein the LED illuminator set having at least one red LED illuminator, one blue LED illuminator, one green LED illuminator, one yellow LED illuminator.

5. The LED bulb as claimed in claim 1, wherein the circuitry controller is connected to the LED illuminator set for controlling each of the LED illuminator of the LED illuminator set to generate the color light.

6. The LED bulb as claimed in claim 1, wherein the decoder is arranged decoding the coded signal so as to generate control signal for controlling the circuitry controller and making the LED illuminator set generating light through the operation of the corresponding buttons.

7. The LED bulb as claimed in claim 1, wherein the receiver is an infrared receiver.

8. The LED bulb as claimed in claim 1, wherein the LED bulb further having a power supply connected to the LED bulb for providing the LED illuminator set power.

9. The LED bulb as claimed in claim 8, wherein the power supply having a circuitry for AC to DC converter and power supply.

10. The LED bulb as claimed in claim 1, wherein the circuitry controller is a switching function circuitry.

11. The LED bulb as claimed in claim 10, wherein the circuitry controller having an amplifier for increasing control signals.

12. The LED bulb as claimed in claim 1, wherein the base further having a plug.

13. The LED bulb as claimed in claim 12, wherein a receiver is connected to the plug by a wire.

14. A LED bulb comprising:
a remote controller for generating coded signal,
a base having a LED illuminator set, a circuitry controller and a decoder,
a globe that is matched with the base to form a light bulb in which the light emitted from the LED illuminator set is mixed,
a base casing for housing the base, and
a receiver arranged on the base casing for receiving signals in code sending from the remote controller.

15. The LED bulb as claimed in claim 14, wherein the remote controller further having a button set that is composed by a plurality of buttons for generating operation signals,
an encoder connected with said buttons for coding the operation signals into the coded signals, and
a transmitter connected to the encoder for sending the coded signals to the receiver.

16. The LED bulb as claimed in claim 14, wherein the LED illuminator set having a plurality of LED illuminator, each of which generates a kind of color light.

17. The LED bulb as claimed in claim 16, wherein the LED illuminator set having at least one red LED illuminator, one blue LED illuminator, one green LED illuminator, one yellow LED illuminator.

18. The LED bulb as claimed in claim 14, the circuitry controller is connected to the LED illuminator set for controlling each of the LED illuminator of the LED illuminator set to generate the color light.

19. The LED bulb as claimed in claim 14, wherein the decoder is arranged between the circuitry controller and the receiver for receiving and decoding the coded signal so as to generate control signal for controlling the circuitry controller and making the LED illuminator set generating light through the operation of the corresponding buttons.

20. The LED bulb as claimed in claim 14, wherein the receiver is an infrared receiver.

21. The LED bulb as claimed in claim 14, wherein the LED bulb further having a power supply connected to the LED bulb for providing the LED illuminator set power.

22. The LED bulb as claimed in claim 21, wherein the power supply having a circuitry for AC to DC converter and power supply.

23. The LED bulb as claimed in claim 14, wherein the circuitry controller is a switching function circuitry.

24. The LED bulb as claimed in claim 23, wherein the circuitry controller having an amplifier for increasing control signals.

25. The LED bulb as claimed in claim 14, wherein the base further having a plug.

26. The LED bulb as claimed in claim 25, wherein a receiver is connected to the plug by a wire.
